(19) United States
(12) Patent Application Publication
(10) Pub. No.: US 2025/0207074 A1
(43) Pub. Date: Jun. 26, 2025

(54) PREPARATION METHOD OF PREPARED FOOD AND PREPARED FOOD

(71) Applicant: Naizhong CUI, Datong City (CN)

(72) Inventor: Naizhong CUI, Datong City (CN)

(21) Appl. No.: 18/977,201

(22) Filed: Dec. 11, 2024

(30) Foreign Application Priority Data
Dec. 25, 2023 (CN) 202311798283.4

(51) Int. Cl. C12G 3/06; B01D 3/00; C12G 1/022; C12H 6/02

(52) U.S. Cl. CPC C12G 3/06; B01D 3/003; C12G 1/0203; C12H 6/02

(57) ABSTRACT

A preparation method of a prepared food and a prepared food are provided. A food raw material is processed by rectification of brouillis, and volatile components in the food raw material are separated from the food raw material through an ethanol-water azeotropic mixture. Low-boiling fractions and high-boiling fractions that cause sensory discomfort are removed, while original aroma components in the food raw material are obtained. The original aroma components are added back to the food raw material to fully restore an original flavor of the food raw material. The ethanol-water azeotropic mixture can kill microorganisms in raw materials of the prepared food by processing the raw materials of the prepared food at a relatively low temperature, thereby ensuring a safety of the prepared food and meeting people's demands for a restoration degree of the prepared food and the requirements of environmental governance and sustainable development.

### CROSS REFERENCE TO RELATED APPLICATION

This patent application claims the benefit and priority of Chinese Patent Application No. 2023117982834, filed with the China National Intellectual Property Administration on Dec. 25, 2023, the disclosure of which is incorporated by reference herein in its entirety as part of the present application.

### TECHNICAL FIELD

A preparation method of a prepared food and a prepared food are provided, belonging to the technical field of prepared foods.

### BACKGROUND

A prepared food refers to a type of product that is stored, circulated, and sold in a packaged or bulk form under a frozen, refrigerated, or room-temperature environment after appropriate processing in a factory or kitchen. Most prepared foods are made from agricultural products, livestock and poultry, as well as aquatic products. These prepared foods can be eaten directly or after simple processing, and have a broad market value due to their convenience and rapidness.

In the processing of existing prepared foods, sterilization is generally conducted chemically or physically. Commonly used chemical methods include ozone sterilization, sodium hypochlorite sterilization, and acid electrolyzed water sterilization; while commonly used physical methods include strong electric field sterilization, ultrasonic sterilization, ultraviolet sterilization, and heat treatment sterilization. However, the above treatment methods always have a great impact on a sensory quality of the prepared foods and cannot retain original aroma components of raw materials for the prepared foods. In addition, impurities, toxic components, or unpleasant odors may be introduced due to the addition of chemical substances. However, there is no report in the prior art on a safer processing process for retaining the original aroma components of prepared foods.

### SUMMARY

A purpose of the present disclosure is to provide a preparation method of a prepared food and a prepared food. The preparation method can retain original aroma components of the prepared food, and the prepared food is healthy and safe and has a high degree of flavor restoration.

The present disclosure provides a preparation method of a prepared food, including the following steps:
subjecting a fruit raw material to selection, fermentation, impurity removal, and distillation to obtain brouillis;
separating volatile components of a food raw material by rectification of the brouillis to obtain a processed food raw material and original aroma components of the food raw material; and
restoring the original aroma components of the food raw material to the processed food raw material to obtain the prepared food.

Preferably, the restoring includes combining the original aroma components of the food raw material with the processed food raw material.

Preferably, the separating includes adding the brouillis into a pot still to allow the rectification, and placing the food raw material in a rectifying column during the rectification.

Preferably, the original aroma components of the food raw material have 65% to 75% alcohol by volume (ABV).

Preferably, the food raw material is selected from the group consisting of a vegetable, a sprout, an edible flower, a fruit, a meat, a fish, a shrimp, a crab, and an alga.

Preferably, a fruit in the fruit raw material is an organic fruit.

Preferably, the fermentation includes first fermentation and second fermentation;
the first fermentation is aerobic fermentation; and
the second fermentation is closed fermentation.

Preferably, the aerobic fermentation is conducted at 26° C. to 28° C. for 6 d to 8 d; and
the closed fermentation is conducted at 24° C. to 26° C. for 28 d to 30 d.

Preferably, an alcohol content of a main part of a distillate in brandy distillation is controlled to be 26% to 29% (ABV) during the distillation.

The present disclosure further provides a prepared food prepared by the preparation method.

### Beneficial Effects:

The present disclosure provides a preparation method of a prepared food, including the following steps: subjecting a fruit raw material to selection, fermentation, impurity removal, and distillation to obtain brouillis; separating volatile components of a food raw material by rectification of the brouillis to obtain a processed food raw material and original aroma components of the food raw material; and restoring the original aroma components of the food raw material to the processed food raw material to obtain the prepared food. In the present disclosure, the food raw material is treated by the rectification of brouillis, which is conducive to the distillation of an ethanol-water azeotropic mixture into a gas. In the process of the gas passing through the rectifying column, volatile aroma components in the food raw material are volatilized and enter the ethanol-water azeotropic mixture. The ethanol-water azeotropic mixture kills microorganisms in the food raw material to make the food raw material safe. By compounding a distilled food raw material with the original aroma components of the food raw material, it is conducive to fully restoring an original flavor of the food raw material. Experiments have shown that the prepared food not only retains the original aroma components of the food, but also does not contain any chemical components harmful to the human body, making it healthier and safer.

That is, the ethanol-water azeotropic mixture formed in the process of preparing prepared food in the present disclosure is at only about 80° C., which is much lower than 100° C., thus significantly reducing the loss of nutrients in food raw material. Meanwhile, due to strong penetration of the ethanol-water azeotropic mixture, there is a broad-spectrum antimicrobial activity, providing a guarantee for the safety of prepared food. The original aroma components after restoration are all derived from natural separation rather than artificial synthesis, meeting the requirements of environmental governance and sustainable development. By using the brouillis, not only the original aroma components in the raw materials of the prepared food are enriched and the safety of prepared food is improved, but also a unique flavor of the prepared food is increased. The preparation of prepared food using the ethanol-water azeotropic mixture greatly simplifies processing procedures of the raw materials of the prepared food. Therefore, the restoration degree of prepared food is significantly improved from the preparation method, such that the prepared food can restore the original aroma components of the food raw material and remove the odor or toxic components that may cause sensory discomfort to the human body in the raw materials of the prepared food. The preparation method also kills the microorganisms that may be contained in the raw materials of the prepared food, and keeps the nutrients of the raw materials of the prepared food from being lost during the preparation, meeting people's demands for the nutrition, safety, and restoration degree of prepared food. Accordingly, the present disclosure is conducive to the industrialization, standardization, normalization, and digitalization of prepared food.

### BRIEF DESCRIPTION OF THE DRAWINGS

To illustrate the examples of the present disclosure or the technical solutions in the prior art more clearly, the accompanying drawings required in the examples will be briefly introduced below.

FIG. 1 shows a schematic diagram of a device for rectification of food raw materials according to the present disclosure; where

reference numerals are: 1—pot still; 2—rectifying column; 3—sieve plate; 4—condenser; 5—original aroma fraction collecting device; 6—low-boiling fraction collecting device; 7—high-boiling fraction collecting device.

### DETAILED DESCRIPTION OF THE EMBODIMENTS

The present disclosure disclosed a preparation method of a prepared food, including the following steps: subjecting a fruit raw material to selection, fermentation, impurity removal, and distillation to obtain brouillis; separating volatile components of a food raw material by rectification of the brouillis to obtain a processed food raw material and original aroma components of the food raw material; and restoring the original aroma components of the food raw material to the processed food raw material to obtain the prepared food.

In the present disclosure, all raw materials and equipment used are commercially available, unless otherwise specified.

In the present disclosure, a preparation process of the brouillis preferably includes: subjecting a fruit raw material to aerobic fermentation, closed fermentation, impurity removal, and distillation in sequence to obtain the brouillis.

In the present disclosure, the fruit raw material is preferably selected. A fruit in the fruit raw material is preferably an organic fruit. In a specific example, the organic fruit is grapes.

In the present disclosure, a selected fruit raw material is preferably subjected to pretreatment. The pretreatment preferably includes washing and crushing the selected fruit raw material; there is no special requirement for washing and crushing methods, and the techniques well known in the art can be used.

In the present disclosure, a crushed fruit raw material is preferably subjected to first fermentation to obtain a first fermentation broth; the first fermentation is preferably aerobic fermentation, preferably a yeast is added into the fruit raw material or the fruit raw material is directly used for the aerobic fermentation; when the yeast is added, there is no special requirement for dosage and source of the yeast, and the techniques well known in the art can be used; the yeast is preferably a special brewing yeast; there is no special limitation on a source of the special brewing yeast, which can be purchased conventionally; the aerobic fermentation is conducted at preferably 26° C. to 28° C. for preferably 6 d to 8 d.

In the present disclosure, the first fermentation broth is preferably subjected to impurity removal. The impurity removal preferably includes coarse filtering of the fruit fermentation broth; a coarse filtering tool preferably includes a filter screen or gauze; there is no special requirement for a mesh size of the filter screen or gauze, as long as it can filter out peel and core in the fermentation broth, and the techniques well known in the art can be used.

In the present disclosure, the first fermentation broth after impurity removal is preferably subjected to second fermentation to obtain a second fermentation broth. The second fermentation is preferably closed fermentation; the closed fermentation is conducted at preferably 24° C. to 26° C. for preferably 28 d to 30 d.

In the present disclosure, the second fermentation broth is preferably finely filtered to obtain a finely filtered second fermentation broth; a fine filtration tool preferably includes a filter; a microporous filter membrane in the filter has a pore size of preferably 0.22 μm, such that bacteria or other tiny substances in the fermentation broth can be removed.

In the present disclosure, the finely filtered second fermentation broth is preferably subjected to first distillation to obtain the brouillis. A device for the first distillation is preferably a pot still; during the first distillation, a rectifying column is preferably added between the pot still and a cooler to remove low-boiling fractions such as methanol and acetaldehyde and high-boiling fractions such as high-grade alcohols that cause sensory discomfort, thereby obtaining a fraction containing special aroma components of alcohol, phenol, acid, and ester as the brouillis. During the first distillation, a main part of a distillate in brandy distillation is preferably detected in real time to obtain a fraction with 26% to 29% ABV; the main part with 26% to 29% ABV is the brouillis; a duration of the first distillation is controlled by detecting the alcohol by volume of the brouillis; there are no special requirements for equipment and parameters of the first distillation, and the techniques well known in the art can be used.

In the present disclosure, volatile components of the food raw material are separated by rectification of the brouillis to obtain a processed food raw material and original aroma components of the food raw material; a separation process preferably includes: placing the food raw material in a rectifying column, and placing the brouillis in a pot still to allow second distillation; during the second distillation, the fraction is preferably detected in real time to obtain aroma components with 65% to 75% ABV; the aroma components with 65% to 75% ABV are the original aroma components of the food raw material; the original aroma components preferably include food raw material aroma fractions, fermented fruit aroma fractions, ethanol, and water; a duration of the second distillation is controlled by detecting the alcohol by volume of the original aroma components of the food raw material.

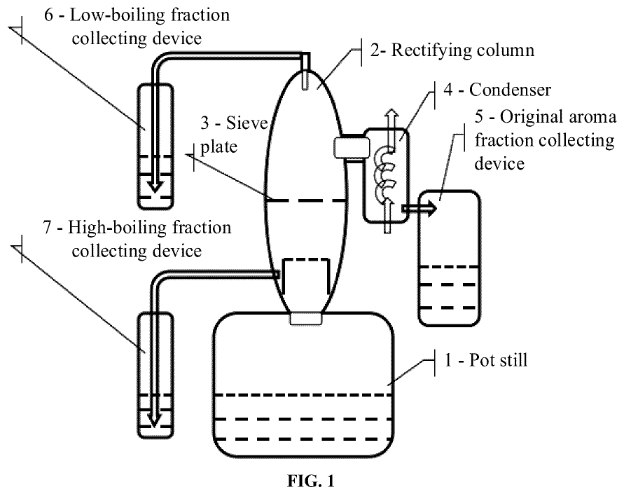

In the present disclosure, the food raw material preferably includes vegetables, sprouts, edible flowers, fruits, meat, fish, shrimps, crabs, or algae; there are no special requirements for the food raw material, as long as they are washed clean. The equipment and parameters for the second distillation are the same as those for the first distillation and will not be described in detail here. During the second distillation, the volatile components in the food raw material are separated from the food raw material through the ethanol-water azeotropic mixture, which can not only remove low-boiling fractions such as methanol and acetaldehyde and high-boiling fractions such as high-grade alcohols that cause sensory discomfort, but also simultaneously obtain the original aroma components in the food raw material and the processed food raw material. In a specific example, a device for the second distillation is shown in FIG. 1. In FIG. 1, the brouillis is added to a pot still 1, and the raw materials of prepared food are added onto a sieve plate 3 in a rectifying column 2. When the pot still 1 is heated, an ethanol-water azeotropic mixture formed by the brouillis passes through the raw materials of prepared food, and a resulting formed mixture is divided into three types of fractions with different boiling points in the rectifying column 2, namely, a low-boiling fraction, an original aroma fraction, and a high-boiling fraction. The original aroma fraction is cooled by a condenser 4 and collected in an original aroma fraction collecting device 5, and is divided into small portions according to proportion and packaged as a prepared food together with the raw materials of prepared food packaged into small bags after preparation. The low-boiling fraction is cooled by a top of the rectifying column 2 and collected in a low-boiling fraction collecting device 6. The high-boiling fraction is cooled by a bottom of the rectifying column 2 and collected in a high-boiling fraction collecting device 7. The device can be purchased conventionally, for example, at https://item.taobao.com/item.htm?spm=a1z09.2.0.0.69072e8dFLXuqV&id=20887788188&_u=o167aumed6d.

In the present disclosure, the original aroma components of the food raw material are preferably restored to the food raw material to obtain the prepared food. The restoring preferably includes combining the processed food raw material and the original aroma components of the food raw material to obtain the prepared food. The combining preferably includes directly mixing the original aroma components of the processed food raw material with the separated food raw material, or separately packaging the processed food raw material and the original aroma components of the separated food raw material and then combining. There is no special requirement for the method of directly mixing, and the techniques well known in the art can be used.

In the present disclosure, the independent packaging preferably includes evenly distributing and independently packaging the original aroma components of the food raw material according to parts of the processed food raw material, so as to obtain the original aroma components after independent packaging. The even distribution and independent packaging are preferably conducted under aseptic conditions; there are no special requirements for even distribution and independent packaging methods.

In the present disclosure, the independently packaged original aroma components and the processed food raw material are combined at a ratio of 1:1 to obtain the prepared food. The processed food raw material is preferably a cooled food raw material; there is no special requirement for a cooling temperature of the processed food raw material, and the techniques well known in the art can be used; the cooling is preferably conducted under sterile conditions. The above technical solution is conducive to restoring the original aroma components obtained by distillation to the food raw material, and at this time toxic or odorous components in the prepared food are removed, while mycetes that cause mold and spoilage or bacteria and viruses that cause diseases are also killed, such that the prepared food is safer.

The present disclosure further provides a prepared food prepared by the preparation method. The prepared food obtained in this way has high flavor restoration and strong safety.

In order to further illustrate the present disclosure, the preparation method of a prepared food and the prepared food provided by the present disclosure is described in detail below in connection with accompanying drawings and examples, but these examples should not be understood as limiting the claimed scope of the present disclosure.

### Example 1

A preparation method of a prepared food included the following steps:

(1) Selecting fruit raw material: organic Cabernet Sauvignon grapes were selected, and after impurity removal they were washed and crushed; where a sugar content of the grape juice was 1.087.

(2) Fermentation: the crushed grape raw material in step (1) was placed in a fermentation tank, and red wine brewing yeast (RW) (purchased from Angel Yeast Co., Ltd.) was added and fully stirred. The first aerobic fermentation was conducted at 26° C. for 8 d, and then the second normal-pressure closed fermentation was conducted at 26° C. The fermentation was terminated when the sugar content of a fermentation broth was ≤3 g/L. The red wine brewing yeast (RW) could be added according to requirements of the instructions.

(3) Impurity removal: the fermentation broth obtained after fermentation in step (2) was placed on a filter screen for coarse filtration to remove peel and core in the fermentation broth. The fermentation broth after coarse filtration was subjected to second normal-pressure closed fermentation. After the second normal-pressure closed fermentation was completed, a large amount of yeast precipitation generated during the fermentation was removed. The fermentation broth was finely filtered, that is, a filter containing a 0.22 μm microporous filter membrane was used to remove residual yeast, bacteria and other impurities in the fermentation broth, so as to avoid affecting a taste quality of the brouillis after distillation, thereby obtaining a filtered fermentation broth.

(4) First distillation: the filtered fermentation broth obtained in step (3) was placed in a pot still to allow distillation, where a rectifying column was added between the pot still and a cooler during the distillation. The rectifying column controlled the removal of low-boiling fractions such as methanol and acetaldehyde and high-boiling fractions such as high-grade alcohols that caused sensory discomfort, thereby obtaining aroma components containing alcohol, phenol, acid, and ester. The main part of a distillate in brandy distillation was controlled to be 26% ABV throughout the distillation, and a resulting distillate was the brouillis.

(5) Second distillation: the brouillis obtained in step (4) was to the pot still to allow further distillation. During distillation, a rectifying column was added between the pot still and a cooler, and then 500 g of dried Datong daylily was added to the rectifying column to allow further distillation. During the distillation, the rectifying column controlled to remove low-boiling fractions such as methanol and acetaldehyde and high-boiling fractions such as high-grade alcohols that caused sensory discomfort, thereby obtaining Datong daylily aroma components including alcohol, phenol, acid, and ester as well as processed Datong daylily. The fraction was controlled to be 72% ABV throughout the distillation, and 5 mL of the Datong daylily aroma components and processed Datong daylily were obtained.

(6) Independent packaging: the processed Datong daylily obtained in step (5) was cooled to 25° C. under sterile conditions and divided into 1 part, while the Datong daylily aroma components obtained in step (5) were evenly distributed and independently packaged under sterile conditions according to corresponding parts, thus obtaining independently packaged Datong daylily and Datong daylily aroma components.

(7) Combination: 1 part of the independently packaged Datong daylily and 5 mL of the Datong daylily aroma components obtained in step (6) were combined and packaged to obtain the prepared food of the present disclosure.

### Example 2

This example differed from Example 1 in that: in step (5), tartary buckwheat seedlings were added into the rectifying column, where after tartary buckwheat seeds germinated, when the hypocotyl grew to about 10 cm, an above-ground part was cut and washed to obtain the tartary buckwheat seedlings;
in step (6), processed tartary buckwheat seedlings and tartary buckwheat seedlings aroma components were obtained by independent packaging; and
in step (7), the independently packaged processed tartary buckwheat seedlings and tartary buckwheat seedlings aroma components were combined and packaged at a ratio of 1:1 to obtain the prepared food of the present disclosure.

### Use Example 1

The Datong daylily aroma components obtained by the preparation method of Example 1 were added into oak chips to allow aging as a sample group (Group JC), while a comparative experiment was conducted by adding oak chips during the aging without adding any Datong daylily into the rectifying column during the whole process as a blank control group (Group JH).

The above two groups of samples were tested by gas chromatography-mass spectrometry (GC-MS) and analyzed by metabolomics methods (commissioned by Shanghai ProfLeader Biotech Co., Ltd.). A VIP value of the first principal component of the OPLS-DA model (threshold >1) combined with a p value of the unidimensional test (threshold <0.05) was used to find differentially expressed metabolites. The results were shown in Table 1. A qualitative method of the differentially expressed metabolites used a search of a self-built standard substance database. Specifically, the AMDIS software was applied to deconvolute mass spectra from raw GC-MS data, and the purified mass spectra were automatically matched with an in-house standard library including retention time and mass spectra, Golm Metabolome Database, and Agilent Fiehn GC/MS Metabolomics RTL Library.

TABLE 1
Differential metabolites between Group JC vs Group JH

| | | | Log₂FC | | |
|---|---|---|---|---|---|
| Metabolites | VIP | p-value | (JC/JH) | HMDB | KEGG |
| 2-Hydroxyacrylate | 1.10 | 2.09E−02 | −0.41 | HMDB0062676 | — |
| 2-Hydroxyglutaric | 1.09 | 2.42E−02 | 0.40 | HMDB0000694 | — |
| acid | | | | | |
| 2-Ketoisovaleric | 1.14 | 6.98E−03 | 0.60 | HMDB0000019 | C00141 |
| acid | | | | | |
| 3,4- | 1.14 | 7.31E−03 | 0.90 | HMDB0000337 | — |
| dihydroxybutyric | | | | | |
| acid | | | | | |
| 3- | 1.06 | 4.18E−02 | 0.32 | HMDB0000700 | C01013 |
| Hydroxypropionic | | | | | |
| acid | | | | | |
| 4-Ethoxy-4- | 1.10 | 2.23E−02 | 0.41 | HMDB0061930 | — |
| oxobutanoic acid | | | | | |
| 4-Hydroxypyridine | 1.10 | 1.79E−02 | 0.47 | — | — |
| Allofuranose | 1.06 | 4.43E−02 | −0.34 | HMDB0001151 | C01487 |
| Arabinose | 1.11 | 1.80E−02 | 0.33 | HMDB0000646 | C00259 |
| Cellobiose | 1.18 | 1.20E−04 | −3.60 | HMDB0000055 | C06422 |
| Citric acid | 1.09 | 2.50E−02 | 0.59 | HMDB0000094 | C00158 |
| Ethyl laurate | 1.08 | 3.20E−02 | 0.66 | HMDB0033788 | — |
| Ethyl linoleate | 1.08 | 3.03E−02 | 0.39 | — | — |
| Ethyl octadecanoate | 1.18 | 2.14E−04 | 1.21 | HMDB0034156 | — |
| Ethyl palmitate | 1.13 | 8.95E−03 | 0.52 | HMDB0029811 | — |
| Ethyl vanillin | 1.08 | 3.05E−02 | 0.56 | HMDB0029665 | — |
| Fumaric acid | 1.14 | 7.26E−03 | 0.59 | HMDB0000134 | C00122 |
| Glycerol | 1.06 | 4.56E−02 | 0.53 | HMDB0000131 | C00116 |
| Glycolic acid | 1.07 | 3.64E−02 | 0.49 | HMDB0000115 | C00160 |
| Isoferulic acid | 1.12 | 1.19E−02 | 0.41 | HMDB0000955 | C10470 |
| Malic acid | 1.13 | 8.69E−03 | 0.95 | HMDB0000744 | C00711 |
| Malonic acid | 1.13 | 9.68E−03 | 0.82 | HMDB0000691 | C00383 |
| Maltose | 1.18 | 2.08E−04 | −5.00 | HMDB0000163 | C00208 |
| Mannobiose | 1.15 | 4.64E−03 | −1.77 | HMDB0029933 | — |
| Monoethyl | 1.16 | 1.85E−03 | 0.77 | HMDB0000576 | — |
| malonic acid | | | | | |
| Oleic acid | 1.05 | 4.95E−02 | 0.40 | HMDB0000207 | C00712 |
| Pyroglutamic acid | 1.15 | 3.71E−03 | 1.27 | HMDB0000267 | C01879 |
| Rhamnose | 1.13 | 9.79E−03 | 0.42 | HMDB0000849 | C00507 |
| Stearic acid | 1.05 | 4.37E−02 | 0.72 | HMDB0000827 | C01530 |
| Succinic acid | 1.08 | 3.32E−02 | 0.54 | HMDB0000254 | C00042 |
| Tetradecanoic acid | 1.17 | 1.39E−03 | 1.91 | HMDB0000806 | C06424 |
| Threose | 0.99 | 4.15E−02 | 0.42 | HMDB0002649 | C01796 |
| Trehalose | 1.10 | 2.00E−02 | −3.42 | HMDB0000975 | C01083 |
| Vanillic acid | 1.07 | 4.03E−02 | 0.45 | HMDB0000484 | C06672 |
| β-Gentiobiose | 1.13 | 1.08E−02 | −1.71 | — | — |

NOTE: VIP, variable importance in the projection, was obtained from the OPLS-DA model; P value was calculated by Student's t-test; Log₂FC, fold change, was calculated as a binary logarithm of the average mass response (normalized peak area) ratio between Group JC vs Group JH, where a positive value meant that the average mass response of the metabolite in Group JC was greater than that in Group JH, while a negative value meant that the average mass response of the metabolite in Group JC was less than that in Group JH

As shown in Table 1, a total of 34 differential metabolites were screened and identified between the Group JC and the Group JH, of which 7 substances decreased and 27 substances increased. In addition, without considering the VIP value, another 1 differential metabolite with increased content was selected. It was seen that the preparation method of a prepared food obtained the Datong daylily aroma components. At the same time, the results showed that no chemical components harmful to the human body were detected in the Datong daylily aroma components, and edible flower prepared foods with different flavors could be developed for different groups of people.

### Use Example 2

The tartary buckwheat seedlings aroma components obtained by the preparation method of Example 2 were added into oak chips to allow aging as a sample group (Group JB), while a comparative experiment was conducted by adding oak chips during the aging without adding any tartary buckwheat seedlings into the rectifying column during the whole process as a blank control group (Group JH).

The above two groups of samples were tested by gas chromatography-mass spectrometry (GC-MS) and analyzed by metabolomics methods (commissioned by Shanghai ProfLeader Biotech Co., Ltd.). A VIP value of the first principal component of the OPLS-DA model (threshold >1) combined with a p value of the unidimensional test (threshold <0.05) was used to find differentially expressed metabolites. The results were shown in Table 2. A qualitative method of the differentially expressed metabolites used a search of a self-built standard substance database. The database was set up the same as that in Use Example 1 and would not be repeated here.

TABLE 2
Differential metabolites between Group JB and Group JH

| | | | Log2FC | | |
|---|---|---|---|---|---|
| Metabolites | VIP | p-value | (JB/JH) | HMDB | KEGG |
| 2,3- | 1.19 | 1.43E−04 | −2.76 | HMDB0003156 | C00265 |
| Dihydroxybutane | | | | | |
| 2-Furoic acid | 1.09 | 1.44E−02 | 0.47 | HMDB0000617 | C01546 |
| 2-Hydroxyglutaric | 1.09 | 1.12E−02 | 0.47 | HMDB0000694 | — |
| acid | | | | | |
| 2-Ketoisovaleric | 1.13 | 5.24E−03 | 0.63 | HMDB0000019 | C00141 |
| acid | | | | | |
| 3,4- | 1.19 | 7.01E−05 | 1.13 | HMDB0000337 | — |
| dihydroxybutyric | | | | | |
| acid | | | | | |
| 3- | 1.16 | 5.19E−03 | 0.46 | HMDB0000700 | C01013 |
| Hydroxypropionic | | | | | |
| acid | | | | | |
| 4-Ethoxy-4- | 1.09 | 3.05E−02 | 0.22 | HMDB0061930 | — |
| oxobutanoic acid | | | | | |
| 4-Hydroxypyridine | 1.14 | 5.82E−03 | 0.58 | — | — |
| Arabinose | 1.09 | 1.34E−02 | 0.36 | HMDB0000646 | C00259 |
| Benzoic acid | 1.15 | 6.85E−03 | 0.67 | HMDB0001870 | C00180 |
| Cellobiose | 1.19 | 1.25E−04 | −3.44 | HMDB0000055 | C06422 |
| Citric acid | 1.18 | 1.03E−03 | 1.14 | HMDB0000094 | C00158 |
| Dodecanoic acid | 1.08 | 4.33E−02 | 0.21 | HMDB0000638 | C02679 |
| Ethyl octadecanoate | 1.14 | 2.82E−03 | 0.61 | HMDB0034156 | — |
| Ethyl tartrate | 1.08 | 2.63E−02 | −2.16 | HMDB0033584 | — |
| Ethyl vanillin | 1.16 | 4.50E−03 | 0.64 | HMDB0029665 | — |
| Fructose | 1.14 | 9.93E−03 | −0.99 | HMDB0000660 | C02336 |
| Fumaric acid | 1.17 | 1.80E−03 | 0.68 | HMDB0000134 | C00122 |
| Glucose | 1.10 | 2.28E−02 | −0.36 | HMDB0000122 | C00031 |
| Glyceric acid | 1.15 | 4.90E−03 | 0.59 | HMDB0000139 | C00258 |
| Glycerol | 1.19 | 3.58E−04 | 0.88 | HMDB0000131 | C00116 |
| Glycolic acid | 1.15 | 4.29E−03 | 0.59 | HMDB0000115 | C00160 |
| Isoferulic acid | 1.16 | 1.33E−03 | 0.70 | HMDB0000955 | C10470 |
| Malic acid | 1.19 | 2.45E−04 | 1.93 | HMDB0000744 | C00711 |
| Malonic acid | 1.15 | 6.11E−03 | 1.07 | HMDB0000691 | C00383 |
| Maltose | 1.19 | 1.94E−04 | −5.98 | HMDB0000163 | C00208 |
| Mannobiose | 1.14 | 7.48E−03 | −1.38 | HMDB0029933 | — |
| Monoethyl | 1.17 | 1.32E−03 | −1.52 | HMDB0000576 | — |
| malonic acid | | | | | |
| Myo-Inositol | 1.15 | 5.05E−03 | 0.52 | HMDB0000211 | C00137 |
| Nicotinic acid | 1.04 | 4.40E−02 | 1.98 | HMDB0001488 | C00253 |
| Oleic acid | 1.07 | 3.44E−02 | 0.33 | HMDB0000207 | C00712 |
| Phosphoric acid | 1.08 | 1.67E−02 | 0.90 | HMDB0002142 | C00009 |
| Pyroglutamic acid | 1.19 | 1.06E−04 | 2.85 | HMDB0000267 | C01879 |
| Rhamnose | 1.12 | 6.94E−03 | 0.50 | HMDB0000849 | C00507 |
| Stearic acid | 1.05 | 4.23E−02 | 0.78 | HMDB0000827 | C01530 |
| Succinic acid | 1.15 | 4.80E−03 | 0.58 | HMDB0000254 | C00042 |
| Tartaric acid | 1.16 | 1.73E−03 | 1.24 | HMDB0000956 | C00898 |
| Tetradecanoic acid | 1.19 | 1.05E−04 | 1.80 | HMDB0000806 | C06424 |
| Threonic acid | 1.10 | 2.03E−02 | 0.63 | HMDB0000943 | C01620 |
| Threose | 1.16 | 1.59E−03 | 0.81 | HMDB0002649 | C01796 |
| Trehalose | 1.11 | 2.06E−02 | −3.30 | HMDB0000975 | C01083 |
| Vanillic acid | 1.16 | 3.86E−03 | 0.53 | HMDB0000484 | C06672 |
| β-Gentiobiose | 1.07 | 2.60E−02 | −1.35 | — | — |

NOTE: VIP, variable importance in the projection, was obtained from the OPLS-DA model; P value was calculated by Student's t-test; Log₂FC, fold change, was calculated as a binary logarithm of the average mass response (normalized peak area) ratio between Group JB vs Group JH, where a positive value meant that the average mass response of the metabolite in Group JB was greater than that in Group JH, while a negative value meant that the average mass response of the metabolite in Group JB was less than that in Group JH. As shown in Table 2, after comparative analysis between the blank control group and the samples aged with oak chips containing tartary buckwheat seedlings aroma components, a total of 43 differential substances were screened and identified between the Group JB and the Group JH, of which 10 substances decreased and 33 substances increased. It was seen that the preparation method of a prepared food obtained the tartary buckwheat seedlings aroma components. At the same time, the results showed that no chemical components harmful to the human body were detected in the tartary buckwheat seedlings aroma components, and sprout prepared foods with different flavors could be developed for different groups of people.

In summary, the prepared food obtained by the above scheme not only retains the original aroma components of the food, but also does not contain any chemical components harmful to the human body, making it healthier and safer.

Although the above example has described the present disclosure in detail, it is only a part of, not all of, the examples of the present disclosure. Other examples may also be obtained by persons based on the example without creative efforts, and all of these examples shall fall within the protection scope of the present disclosure.

What is claimed is:

1. A preparation method of a prepared food, comprising the following steps:
subjecting a fruit raw material to selection, fermentation, impurity removal, and distillation to obtain brouillis;
separating volatile components of a food raw material by rectification of the brouillis to obtain a processed food raw material and original aroma components of the food raw material; and
restoring the original aroma components of the food raw material to the processed food raw material to obtain the prepared food.

2. The preparation method according to claim 1, wherein the restoring comprises combining the original aroma components of the food raw material with the processed food raw material.

3. The preparation method according to claim 1, wherein the separating comprises adding the brouillis into a pot still to allow rectification, and placing the food raw material in a rectifying column during the rectification.

4. The preparation method according to claim 1, wherein the original aroma components of the food raw material have 65% to 75% alcohol by volume (ABV).

5. The preparation method according to claim 1, wherein the food raw material is selected from the group consisting of a vegetable, a sprout, an edible flower, a fruit, a meat, a fish, a shrimp, a crab, and an alga.

6. The preparation method according to claim 1, wherein a fruit in the fruit raw material is an organic fruit.

7. The preparation method according to claim 1, wherein the fermentation comprises first fermentation and second fermentation;
the first fermentation is aerobic fermentation; and
the second fermentation is closed fermentation.

8. The preparation method according to claim 1, wherein the aerobic fermentation is conducted at 26° C. to 28° C. for 6 d to 8 d; and
the closed fermentation is conducted at 24° C. to 26° C. for 28 d to 30 d.

9. The preparation method according to claim 1, wherein a main part of a distillate in brandy distillation is controlled to be 26% to 29% ABV during the distillation.

10. A prepared food prepared by the preparation method according to claim 1.

11. The preparation method according to claim 2, wherein the original aroma components of the food raw material have 65% to 75% alcohol by volume (ABV).

12. The preparation method according to claim 3, wherein the original aroma components of the food raw material have 65% to 75% alcohol by volume (ABV).

13. The preparation method according to claim 2, wherein the food raw material is selected from the group consisting of a vegetable, a sprout, an edible flower, a fruit, a meat, a fish, a shrimp, a crab, and an alga.

14. The preparation method according to claim 3, wherein the food raw material is selected from the group consisting of a vegetable, a sprout, an edible flower, a fruit, a meat, a fish, a shrimp, a crab, and an alga.

15. The prepared food according to claim 10, wherein the restoring comprises combining the original aroma components of the food raw material with the processed food raw material.

16. The prepared food according to claim 10, wherein the separating comprises adding the brouillis into a pot still to allow rectification, and placing the food raw material in a rectifying column during the rectification.

17. The prepared food according to claim 10, wherein the original aroma components of the food raw material have 65% to 75% alcohol by volume (ABV).

18. The prepared food according to claim 10, wherein the food raw material is selected from the group consisting of a vegetable, a sprout, an edible flower, a fruit, a meat, a fish, a shrimp, a crab, and an alga.

19. The prepared food according to claim 10, wherein a fruit in the fruit raw material is an organic fruit.

20. The prepared food according to claim 10, wherein the fermentation comprises first fermentation and second fermentation;
the first fermentation is aerobic fermentation; and
the second fermentation is closed fermentation.
